(19) United States
(12) Patent Application Publication
(10) Pub. No.: US 2026/0124989 A1
(43) Pub. Date: May 7, 2026

(54) LAMP SYSTEM FOR MOVING VEHICLES

(71) Applicant: HYUNDAI MOBIS CO., LTD., Seoul (KR)

(72) Inventor: Myeong Je KIM, Youngin-si (KR)

(73) Assignee: HYUNDAI MOBIS CO., LTD., Seoul (KR)

(21) Appl. No.: 19/290,747

(22) Filed: Aug. 5, 2025

(30) Foreign Application Priority Data
Nov. 7, 2024 (KR) 10-2024-0157295

(51) Int. Cl. B60Q 5/00; B60Q 1/00

(52) U.S. Cl. CPC B60Q 5/008; B60Q 1/0023

(57) ABSTRACT

A lamp system for a vehicle including an audio module to output sound, a light source module including at least one light source to output an image, and a control module to control output of the light source module and the audio module based on image data and control signals received from the vehicle. The control module transmits an video signal and an audio signal that is synchronized with the video signal, based on the image data and the control signals, to control the output of the light source module and the audio module, respectively.

### CROSS-REFERENCE TO RELATED APPLICATION

The present application claims priority to Korean Patent Application No. 10-2024-0157295, filed on November 7, 2024, the entire contents of which is incorporated herein for all purposes by this reference.

### BACKGROUND

### Field of the Invention

The present invention relates to a lamp system for a moving vehicle, and more particularly, to a sound-linked lamp system provided in a moving vehicle.

### Description of the Related Art

VESS stands for Virtual Engine Sound System, and it is a system designed to address the issue where pedestrians and nearby vehicles may have difficulty detecting an eco-friendly moving vehicle, such as an electric vehicle, due to its low noise. VESS emits artificially generated sounds when the vehicle is in motion, thereby helping the surrounding environment detect the approach of the vehicle.

In 2022, a regulation related to road surface information display was enacted, which includes four symbols intended to provide warnings to the driver. Specifically, the symbols convey meanings such as slippery road surface warning, collision warning, wrong route warning, and lane departure warning.

However, with conventional communication lamps, it may be difficult for pedestrians to communicate effectively using only visual information. According to a comparison of information reception capacity by sensory organs, vision and hearing account for approximately 83% and 11%, respectively, indicating that these are the most dominant senses. Therefore, there is a need for a communication lamp capable of enhancing information delivery by simultaneously outputting an audio signal synchronized with the video signal emitted from a conventional communication lamp.

Moreover, in the case of conventional communication lamp control systems, only a video signal interface is implemented. Accordingly, to output sound in synchronization with video, a technology is needed that can control both video and audio using only the video signal.

### Documents of Related Art

(Patent Document 1) Korean Patent Publication No. 10-2021-0105611 ("Vehicle and Control Method Thereof," Publication Date: August 27, 2021)

### SUMMARY

The present invention has been devised to solve the above problems, and it is an object of the present invention to provide a lamp system for a moving vehicle capable of outputting sound.

In order to solve the above problems, a lamp system for a vehicle according to various embodiments of the present invention includes an audio module configured to output sound, a light source module including at least one light source and configured to output an image, and a control module configured to control output of the light source module and the audio module based on image data and control signals received from the vehicle. The control module is configured to transmit a video signal and an audio signal that is synchronized with the video signal, based on the image data and the control signals, to control the output of the light source module and the audio module, respectively.

In addition, the control module may include a deserializer configured to receive the serialized image data, convert the serialized image data into parallel data, and generate a pixel clock (PCLK), a horizontal synchronization signal (HSYNC), and a vertical synchronization signal (VSYNC) for the parallel data based on the control signals, and a processor configured to receive the pixel clock (PCLK), the horizontal synchronization signal (HSYNC), and the vertical synchronization signal (VSYNC) from the deserializer, detect a start and an end of the image data, and transmit the video signal and the audio signal based on the detection.

In addition, the processor may be configured to recognize the start and the end of the image data based on a variation pattern of the horizontal synchronization signal (HSYNC) and the vertical synchronization signal (VSYNC).

In addition, the processor may be configured to pre-store timing information of the horizontal synchronization signal (HSYNC) and the vertical synchronization signal (VSYNC), and to recognize completion of transmission of the image data based on no additional signal variation being detected at a predetermined timing.

In addition, the deserializer may be configured to generate a lock signal (LOCK) upon a start of input of the pixel clock (PCLK) to the processor, and the processor may be configured to start receiving the image data upon the lock signal (LOCK) transitioning to a high (H) state.

In addition, the deserializer may be configured to generate an interrupt signal upon the lock signal (LOCK) transitioning to the high (H) state, prompting the processor to start receiving the image data.

In addition, the processor may be configured to output a specific audio content as the audio signal, the specific audio content being selected based on a clock frequency of the video signal.

In addition, the processor may be configured output a white or black frame as the video signal during an initial predetermined number of frames.

The lamp system may further include a communication line connecting an output terminal for the image data and the processor, wherein the processor may be configured to select a specific audio content based on index (INDEX) information received through the communication line and output the selected content as the audio signal.

In addition, the processor may be configured to receive volume information or sensor information related to the audio through the communication line and change volume status information displayed externally based on the received volume information or senso information.

### BRIEF DESCRIPTION OF THE DRAWINGS

FIG. 1 is a schematic diagram illustrating a lamp system for a moving vehicle according to an embodiment of the present invention;

FIG. 2 is a timing diagram illustrating audio signal output in the lamp system of FIG. 1;

FIG. 3 is a schematic diagram illustrating a lamp system for a moving vehicle according to another embodiment of the present invention; and

FIG. 4 is a schematic diagram illustrating an output image according to yet another embodiment of the present invention.

### DETAILED DESCRIPTION

To explain the present invention, its operational advantages, and the objectives achieved through its implementation, preferred embodiments of the present invention are illustrated and described below with reference thereto.

First, the terms used in this application are merely intended to describe specific embodiments and are not intended to limit the scope of the present invention, and singular expressions may include plural expressions unless the context clearly indicates otherwise. Additionally, in this application, terms such as "comprising" or "having" are intended to indicate the presence of the features, numbers, steps, operations, components, parts, or combinations thereof described in the specification, but do not preclude the presence or addition of one or more other features, numbers, steps, operations, components, parts, or combinations thereof.

In describing the present invention, detailed descriptions of well-known configurations or functions may be omitted so as not to obscure the subject matter of the invention.

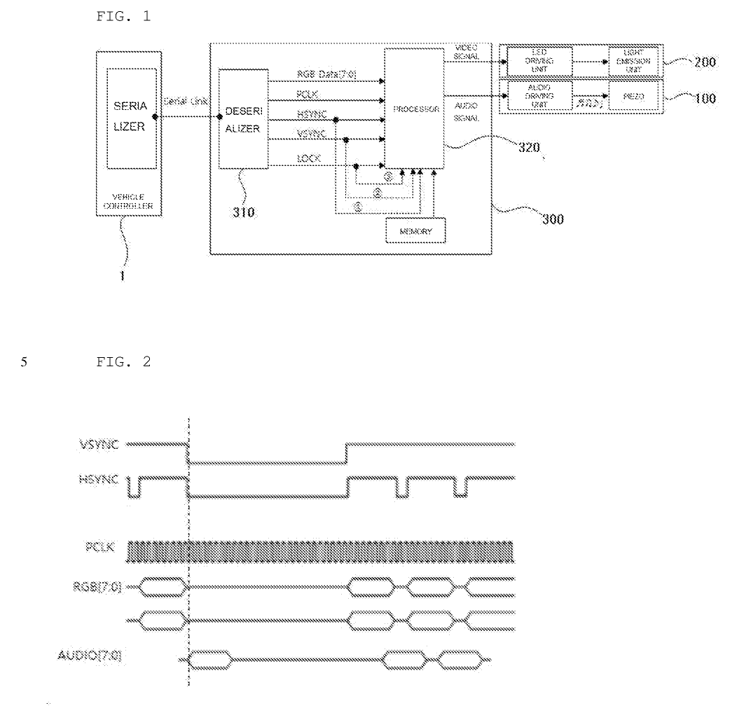

FIG. 1 is a schematic diagram illustrating a lamp system for a moving vehicle according to an embodiment of the present invention, and FIG. 2 is a timing diagram illustrating audio signal output in the lamp system of FIG. 1.

As shown in FIG. 1, a lamp system 1000 for a moving vehicle?1000 according to the present invention may include an audio module 100, a light source module 200, and a control module 300.

First, the audio module?100 may receive an audio signal from the control module?300 and output sound. In this case, the audio module?100 may include a diaphragm and receive audio through vibration.

The light source module?200 may receive a video signal from the control module?300 and output an image. The light source module?200 may include at least one light source and may generate a beam using the light source.

The control module?300 may control the outputs of the light source module?200 and the audio module?100 based on image data of the lamp system. Specifically, the control module?300 may output a video signal and an audio signal based on the image data and control signal received from a vehicle controller?1, and may control the outputs of the light source module?200 and the audio module?100 accordingly. In this case, the video signal and audio signal output by the control module?300 may be synchronized as shown in FIG. 2.

Hereinafter, methods of controlling the audio signal will be described in detail through various embodiments.

### First embodiment

According to a first embodiment, the control module?300 may control the audio signal in synchronization with a video signal based on a video clock signal.

Specifically, the control module?300 may include a deserializer 310 and a processor 320.

The deserializer 310 may receive serialized video data from the vehicle controller 1 and convert the data into parallel data. In addition, the deserializer 310 may receive control signals from the vehicle controller 1 and generate a pixel clock PLCK, a horizontal synchronization signal HSYNC, and a vertical synchronization signal VSYNC for the parallel data.

Here, the horizontal synchronization signal HSYNC indicates the start of each horizontal line in the video signal, allowing the display to recognize the end of the current line and transition to the next.

The vertical synchronization signal VSYNC indicates the start of a new frame in the video signal and is used to synchronize the display for that frame.

The processor 320 may receive the pixel clock PLCK, the horizontal synchronization signal HSYNC, and the vertical synchronization signal VSYNC from the deserializer 310, and may detect the start and end of the video data based on the HSYNC and VSYNC signals. Based on this detection, the processor 320 may transmit the video signal and the audio signal.

In this case, the processor 320 may recognize the start and end of the video data based on the variation patterns of the HSYNC and VSYNC signals. Specifically, the processor 320 may recognize the start and end of a new frame from rising or falling transitions of the vertical synchronization signal VSYNC, and may prepare to read and store data at specific pixel positions by tracking the start and end of each line within a frame using the horizontal synchronization signal HSYNC.

In particular, since the processor 320 is preconfigured with information on the horizontal and vertical synchronization signals HSYNC and VSYNC, it may determine that the transmission of video data is complete when no additional signals are input at a predetermined timing. For this purpose, timing information for the horizontal and vertical synchronization signals HSYNC and VSYNC may be pre-stored.

Meanwhile, the deserializer 310 may generate a lock signal LOCK indicating a stable reception state when the pixel clock PLCK begins to be input to the processor 320. In addition, when the lock signal LOCK transitions to a high H state, the processor 320 may start receiving the video data. In this case, the deserializer 310 may also generate an interrupt signal when the lock signal LOCK transitions to the high H state, thereby prompting the processor 320 to start receiving the video data.

### Second embodiment

According to a second embodiment, the control module 300 may select the content of the audio signal based on the video clock signal.

Specifically, when synchronizing the audio signal using the clock information of the video signal, the audio content output may vary depending on the clock frequency. More specifically, the processor 320 may output a specific audio content selected according to the clock frequency of the video signal as the audio signal. For example, when the horizontal synchronization signal HSYNC is 100 Hz, the audio content may be INDEX1; when HSYNC is 200 Hz, the audio content may be INDEX2; when HSYNC is 300 Hz, the audio content may be INDEX3; and when HSYNC is 400 Hz, the audio content may be INDEX4. In this case, the processor 320 may output a white or black frame as the video signal during an initial predetermined frame period to enable the confirmation of the clock information.

### Third embodiment

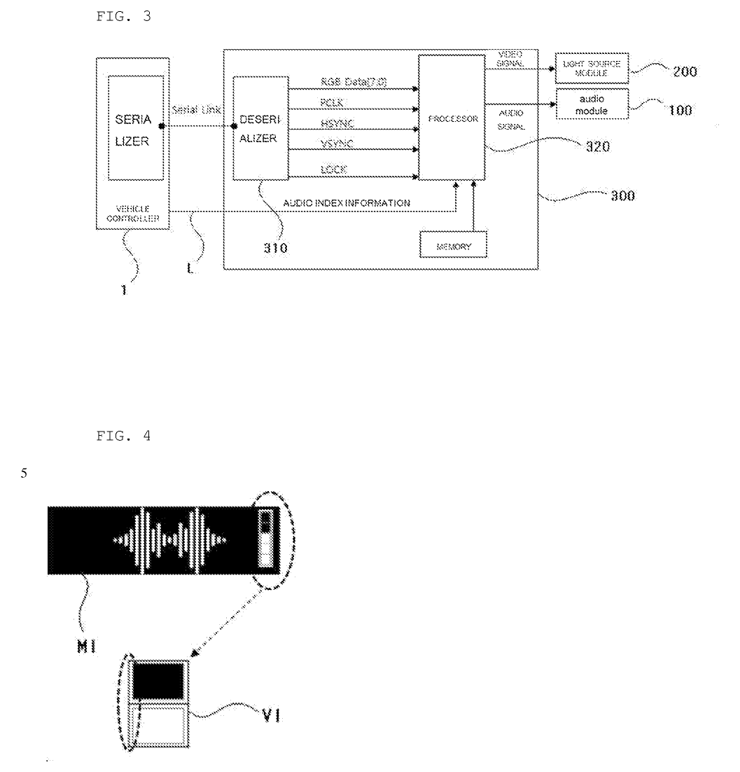

FIG. 3 is a schematic diagram illustrating a lamp system for a moving vehicle according to another embodiment of the present invention.

According to a third embodiment, the processor 320 may identify the audio content through a separate communication line.

Specifically, as shown in FIG. 3, the lamp system 1000 for a moving vehicle according to the present invention may further include a communication line L.

The communication line L may connect the vehicle controller 1 and the processor 320, and the processor 320 may receive control signals through the communication line L and select the corresponding audio content based on the included index (INDEX) information to output as the audio signal.

### Fourth embodiment

FIG. 4 is a schematic diagram illustrating an output image according to yet another embodiment of the present invention.

According to a fourth embodiment, the processor 320 may output sound volume level images.

Specifically, as shown in FIG. 4, the processor 320 may receive volume information or sensor information related to the audio from the vehicle controller 1 through a communication line L connected between the vehicle controller 1 and the processor 320, and based on this, may change the status information of the volume displayed externally.

More specifically, the processor 320 may overlap a volume image VI, pre-stored in the main image MI of the video signal, and output the video signal. When the video signal includes a black-and-white image, processing the volume image VI with a single line may cause it to be obscured by the main image MI, making it difficult to recognize the current volume level. Therefore, the processor 320 may process the outer edge of the volume image with a double border or more and overlap it with the main image to output the video signal.

According to various embodiments of the present invention as described above, the lamp system for a moving vehicle is capable of independently outputting not only images but also sound from the communication lamp, thereby enhancing the information recognition ability of pedestrians and drivers.

While preferred embodiments of the present invention have been described above, the embodiments disclosed herein are intended to be illustrative and not limiting of the scope of the invention. Accordingly, the technical scope of the invention is not limited to the disclosed embodiments but encompasses combinations of the disclosed embodiments, and the scope of the invention is not limited by these embodiments. Furthermore, it will be apparent to those skilled in the art that various changes and modifications can be made to the present invention without departing from the spirit or scope of the attached claims, and all such variations and modifications are intended to fall within the scope of the present invention.

### DESCRIPTION OF REFERENCE NUMERALS

1: vehicle controller

1000: lamp system for a moving vehicle

100: audio module

200: light source module

300: control module

310: deserializer

320: processor

L: communication line

What is claimed is:

1. A lamp system for a vehicle, the system comprising:
an audio module configured to output sound;
a light source module including at least one light source and configured to output an image; and
a control module configured to control output of the light source module and the audio module based on image data and control signals received from the vehicle,
wherein the control module is configured to transmit a video signal and an audio signal that is synchronized with the video signal, based on the image data and the control signals, to control the output of the light source module and the audio module, respectively.

2. The lamp system of claim 1, wherein the control module comprises:
a deserializer configured to receive serialized image data, convert the serialized image data into parallel data, and generate a pixel clock (PCLK), a horizontal synchronization signal (HSYNC), and a vertical synchronization signal (VSYNC) for the parallel data based on the control signals; and
a processor configured to receive the pixel clock (PCLK), the horizontal synchronization signal (HSYNC), and the vertical synchronization signal (VSYNC) from the deserializer, detect a start and an end of the image data, and transmit the video signal and the audio signal based on the detection.

3. The lamp system of claim 2, wherein the processor is configured to recognize the start and the end of the image data based on a variation pattern of the horizontal synchronization signal (HSYNC) and the vertical synchronization signal (VSYNC).

4. The lamp system of claim 3, wherein the processor is configured to pre-store timing information of the horizontal synchronization signal (HSYNC) and the vertical synchronization signal (VSYNC), and to recognize completion of transmission of the image data based on no additional signal variation being detected at a predetermined timing.

5. The lamp system of claim 3, wherein the deserializer is configured to generate a lock signal (LOCK) upon a start of input of the pixel clock (PCLK) to the processor, and the processor is configured to start receiving the image data upon the lock signal (LOCK) transitioning to a high (H) state.

6. The lamp system of claim 5, wherein the deserializer is configured to generate an interrupt signal upon the lock signal (LOCK) transitioning to the high (H) state, prompting the processor to start receiving the image data.

7. The lamp system of claim 2, wherein the processor is configured to output a specific audio content as the audio signal, the specific audio content being selected based on a clock frequency of the video signal.

8. The lamp system of claim 7, wherein the processor is configured to output a white or black frame as the video signal during an initial predetermined number of frames.

9. The lamp system of claim 2, further comprising a communication line connecting an output terminal for the image data and the processor,
wherein the processor is configured to select a specific audio content based on index (INDEX) information received through the communication line, and to output the selected content as the audio signal.

10. The lamp system of claim 9, wherein the processor is configured to receive volume information or sensor information related to the audio through the communication line, and to change volume status information displayed externally based on the received volume information or senso information.
